(19) United States
(12) Patent Application Publication
(10) Pub. No.: US 2025/0233333 A1
(43) Pub. Date: Jul. 17, 2025

(54) Electrical Connector

(71) Applicants: Dongguan Tarng Yu Electronics Co., Ltd., Dongguan City (CN); Tarng Yu Enterprise co., ltd., New Taipei City (TW)

(72) Inventors: TSUNG-CHI CHEN, New Taipei City (TW); MU-JUNG HUANG, New Taipei City (TW)

(21) Appl. No.: 19/017,321

(22) Filed: Jan. 10, 2025

(30) Foreign Application Priority Data
Jan. 12, 2024 (TW) 113200484

(51) Int. Cl. H01R 12/77; H01R 13/24; H01R 13/506; H01R 13/6582; H01R 13/66

(52) U.S. Cl. CPC H01R 12/778; H01R 13/24; H01R 13/506; H01R 13/6582; H01R 13/6658

(57) ABSTRACT

An electrical connector, and the electrical connector is manufactured through an assembly method, enabling the assembly of conductive terminals tailored to the requirements of electronic devices, thereby achieving customized adjustment of the number of conductive terminals in the electrical connector according to the demands. Additionally, the electrical connector comprises a circuit board capable of accommodating electronic elements, ensuring that the electrical characteristics of the electrical connector meet the requirements of electronic devices.

### CROSS-REFERENCE TO RELATED APPLICATIONS

This application claims the priority of Republic of China Patent Application No. 113200484 filed on Jan. 12, 2024, in the State Intellectual Property Office of the R.O.C., the disclosure of which is incorporated herein by reference.

### BACKGROUND OF THE INVENTION

### Field of the Invention

This application relates to an electrical connector, and more specifically, it refers to an electrical connector manufactured through an assembly method.

### Descriptions of the Related Art

Electrical connectors are widely used in various electronic devices. In recent years, electrical connectors have been designed to be equipped with inserting components. Generally, electrical connectors comprise conductive terminals, enabling conductive terminals to join with inserting components which are equipped to be used, allowing the conductive terminals and the inserting components to form a signal transmission component to transmit electrical signals within electronic devices.

In response to the requirements of electronic devices, the number of conductive terminals in electrical connectors may need to be customized. However, in current electrical connector designs, once completed, the number of conductive terminals is determined and cannot be customized or adjusted.

Therefore, how to customize and adjust the number of conductive terminals in electrical connectors has become a pressing technological challenge that the industry is eager to overcome.

### SUMMARY OF THE INVENTION

In view of the drawbacks of the prior art mentioned above, the present application provides an electrical connector, and the electrical connector is capable of providing inserting for an inserting component, wherein the inserting component comprises an inserting component inserting structure, and the inserting component inserting structure comprises a major inserting component joining part and a minor inserting component joining part, and the electrical connector comprises: a major circuit board, comprising a first major terminal connection circuit and a second major terminal connection circuit; a conductive terminal assembly, comprising a first major conductive terminal, a second major conductive terminal, and a first minor conductive terminal; a major insulation assembly base, joining the major circuit board, the first major conductive terminal, and the second major conductive terminal, enabling the first major conductive terminal to be electrically connected to the first major terminal connection circuit and the second major conductive terminal to be electrically connected to the second major terminal connection circuit; and an insulation plastic core, comprising a major space side, a minor space side, a plastic core inserting space, and a plastic core assembly space, and the plastic core assembly space provides the assembly of the major insulation assembly base and the first minor conductive terminal, positioning the first major conductive terminal and the second major conductive terminal on the major space side and extending into the plastic core inserting space respectively, and positioning the first minor conductive terminal on the minor space side and extending into the plastic core inserting space; wherein, during insertion of the inserting component, the inserting component inserting structure can enter the plastic core inserting space, positioning the major inserting component joining part within the major space, and positioning the minor inserting component joining part on the minor space side, enabling the major inserting component joining part to join with the first major conductive terminal and the second major conductive terminal on the major space side, and enabling the minor inserting component joining part to join with the first minor conductive terminal on the minor space side.

Preferably, the electrical connector said above, further comprising a major electronic element, wherein the major electronic element is positioned on the major circuit board, and the major electronic element comprises a first major electronic element pin and a second major electronic element pin, wherein the first major electronic element pin is electrically connected to the first major terminal connection circuit, and the second major electronic element pin is electrically connected to the second major terminal connection circuit.

Preferably, the electrical connector said above, wherein the major insulation assembly base comprises an assembly base embedding space, and the assembly base embedding space provides space for embedding the major electronic element, thereby avoiding the major electronic element interfering that the inserting component inserting structure enters the plastic core inserting space.

Preferably, the electrical connector said above, wherein the first major conductive terminal comprises a first major terminal inserting pin, and the first major terminal inserting pin is inserted into the first major terminal connection circuit, enabling the first major conductive terminal to be electrically connected to the first major terminal connection circuit, similarly, the second major conductive terminal comprises a second major terminal inserting pin, and the second major terminal inserting is inserted into the second major terminal connection circuit, enabling the second major conductive terminal to be electrically connected to the second major terminal connection circuit.

Preferably, the electrical connector said above, wherein the first major conductive terminal and the second major conductive terminal are substantially identical in form.

Preferably, the electrical connector said above, wherein the insulation plastic core also comprises a plastic core embedding space, and the plastic core embedding space provides embedding of the major insulation assembly base, thereby avoiding the major insulation assembly base interfering that the inserting component inserting structure enters the plastic core inserting space.

Preferably, the electrical connector said above, further comprising a shielding cover, and the shielding cover can be joined with the insulation plastic core to provide shielding for the plastic core assembly space.

Preferably, the electrical connector said above, wherein the electrical connector is capable of being equipped with a first minor conductive cable, wherein the first minor conductive terminal comprises a first minor terminal cable clamping structure, and the first minor terminal cable clamping structure can electrically clamp the first minor conductive cable within the plastic core assembly space, additionally, the insulation plastic core further comprises a plastic core supporting structure positioned beneath the first minor terminal cable clamping structure to provide structural support for the first minor terminal cable clamping structure.

Preferably, the electrical connector said above, wherein the shielding cover comprises a shielding cover cable passing hole, and the shielding cover cable passing hole provides the first minor conductive cable to pass through, enabling the first minor conductive cable to enter the plastic core assembly space.

Preferably, the electrical connector said above, wherein the electrical connector is capable of being equipped with a second minor conductive cable, wherein the conductive terminal assembly further comprises a second minor conductive terminal, and the second minor conductive cable is respectively connected to the first minor conductive terminal and the second minor conductive terminal, thereby enabling the first minor conductive terminal to be electrically connected with the second minor conductive terminal.

Preferably, the electrical connector said above, wherein the first minor conductive terminal and the second minor conductive terminal are substantially identical in form.

Preferably, the electrical connector said above, wherein the insulation plastic core further comprises a plastic core minor terminal assembly structure, and the plastic core minor terminal assembly structure is located within the plastic core assembly space, providing the assembly of the first minor conductive terminal and the second minor conductive terminal.

In comparison to prior art, this application provides an electrical connector, and the electrical connector is manufactured through an assembly method, enabling the assembly of conductive terminals tailored to the requirements of electronic devices, thereby achieving customized adjustment of the number of conductive terminals in the electrical connector according to the demands. Additionally, the electrical connector comprises a circuit board capable of accommodating electronic elements, ensuring that the electrical characteristics of the electrical connector meet the requirements of electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic diagram of the electrical connector of the present application from a first perspective in an embodiment.

FIG. 2 is a three-dimensional schematic diagram of the electrical connector of the present application from a second perspective in an embodiment.

FIG. 3 is a three-dimensional schematic diagram of the electrical connector of the present application from a third perspective in an embodiment.

FIG. 4 is a three-dimensional schematic diagram of some components of the electrical connector according to the present application from a first perspective in an embodiment.

FIG. 5 is a three-dimensional schematic diagram of some components of the electrical connector according to the present application from a second perspective in an embodiment.

FIG. 6 is a three-dimensional schematic diagram of some components of the electrical connector according to the present application from a first perspective in an embodiment.

FIG. 7 is a three-dimensional schematic diagram of some components of the electrical connector according to the present application from a second perspective in an embodiment.

FIG. 8 is a three-dimensional schematic diagram of some components of the electrical connector according to the present application from a first perspective in an embodiment.

FIG. 9 is a three-dimensional schematic diagram of some components of the electrical connector according to the present application from a second perspective in an embodiment.

FIG. 10 is a three-dimensional schematic diagram of some components of the electrical connector according to the present application in an embodiment.

FIG. 11 is a three-dimensional schematic diagram of some components of the electrical connector according to the present application in an embodiment.

FIG. 12 is a three-dimensional schematic diagram of some components of the electrical connector according to the present application in an embodiment.

FIG. 13 is a three-dimensional schematic diagram of some components of the electrical connector according to the present application in an embodiment.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Additionally, structures or elements with the same or similar functions in the following embodiments will be explained using the same symbols, and descriptions of the same or equivalent technical features will be omitted to make the disclosed content more concise and understandable.

This application provides an electrical connector, and the electrical connector comprises a plastic core assembly space, enabling the assembly of conductive terminals tailored to the requirements of electronic devices, thereby achieving customized adjustment of the number of conductive terminals in the electrical connector according to the demands.

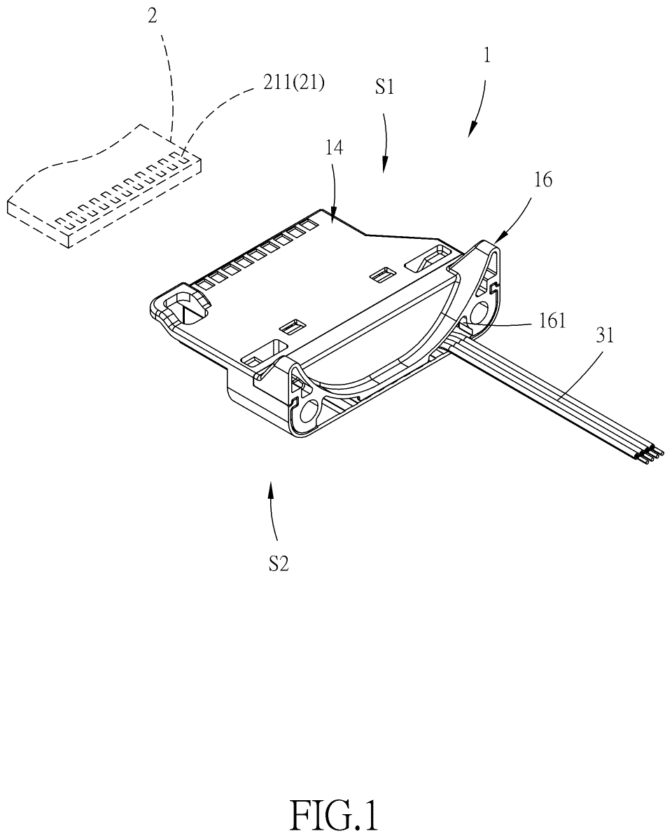

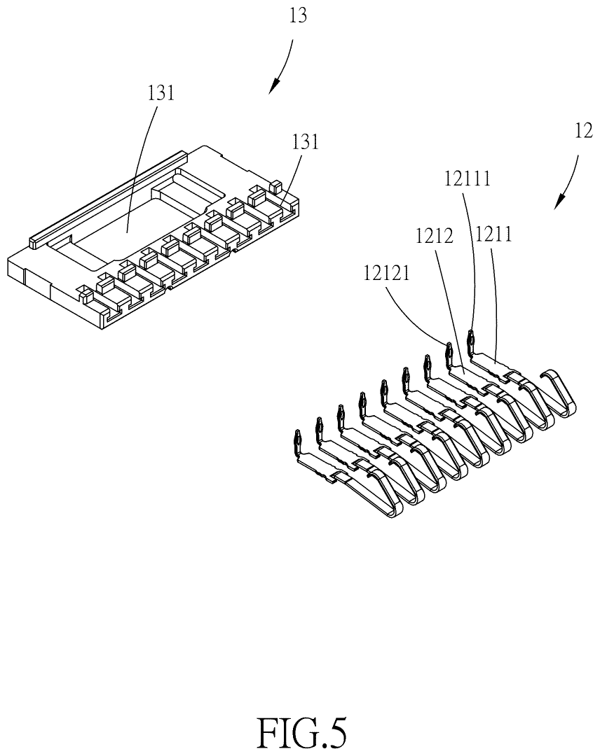

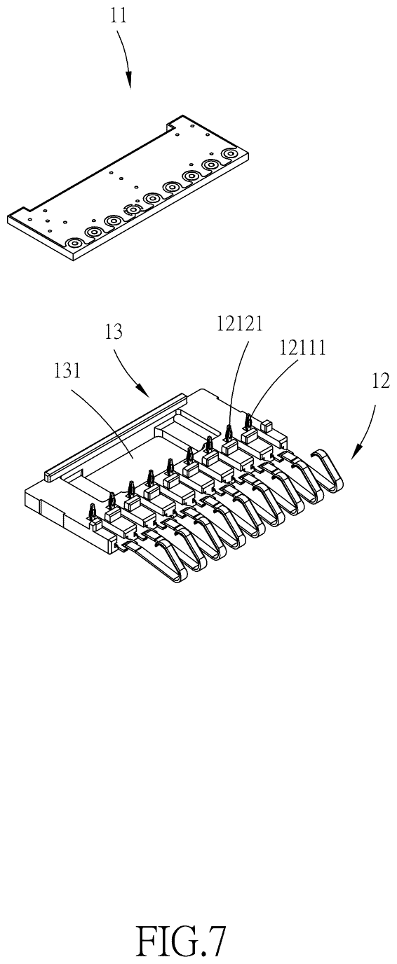

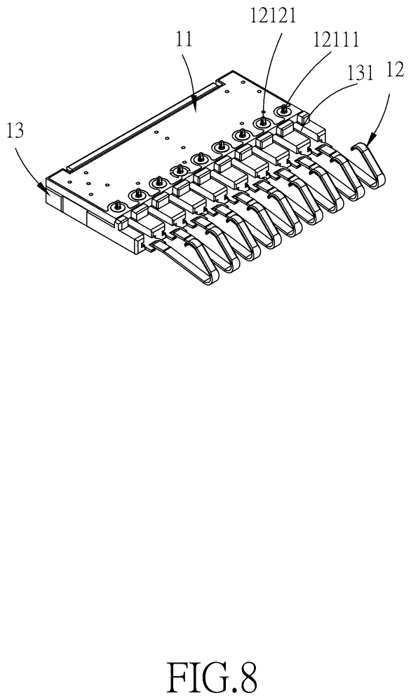

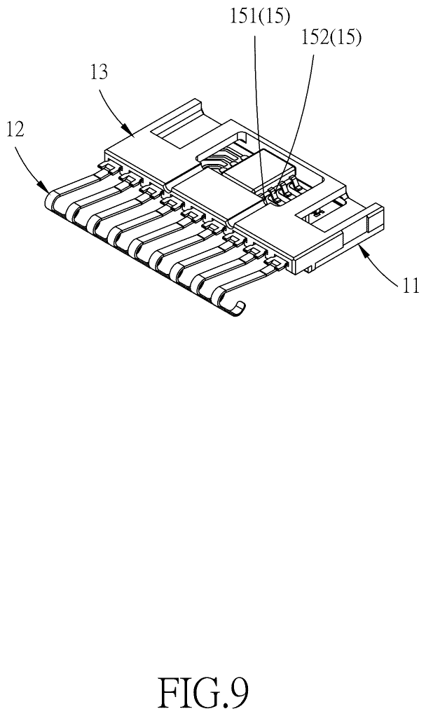

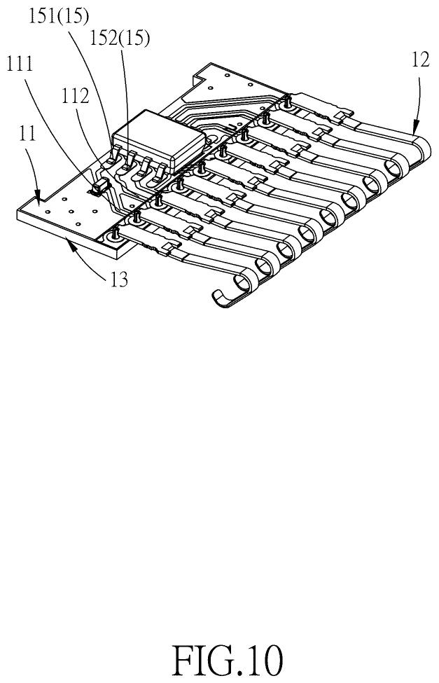

For a detailed description of the embodiments disclosed in the present application, please refer to FIGS. 1 to 13.

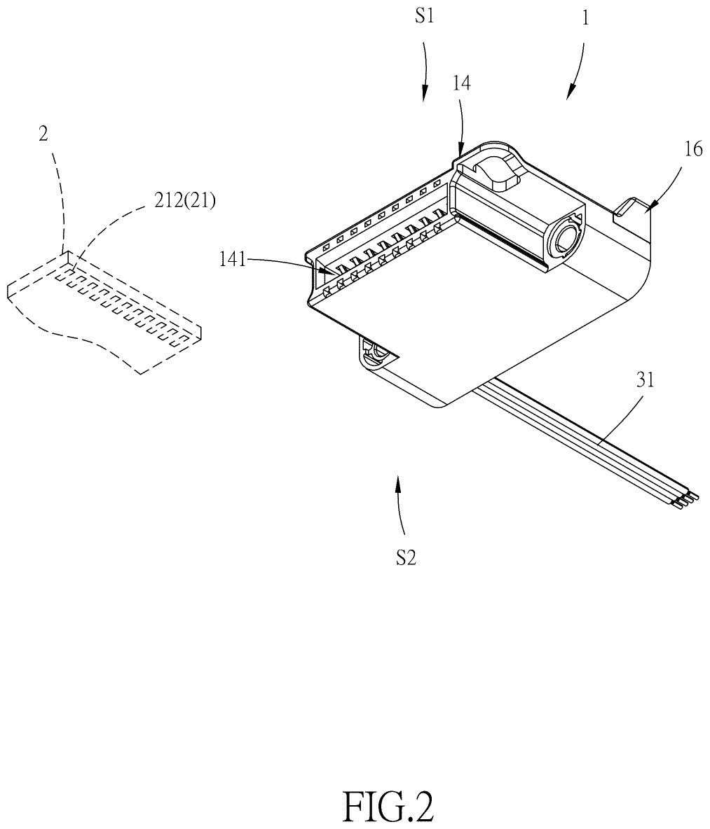

In the embodiments shown in FIGS. 1 to 2, at least one electrical connector 1 is disclosed, and the electrical connector is capable of providing inserting for to insert an inserting component 2. It should be noted that the inserting component 2 can be optionally an electrical connector or a circuit board. The inserting component 2 comprises an inserting component inserting structure 21, and the inserting component inserting structure 21 may be, for example, a tongue-shaped inserting structure, comprising a major inserting component joining part 211 and a minor inserting component joining part 212. The major inserting component joining part 211 and the minor inserting component joining part 212 are, for example, circuit or conductive structures capable of providing to join and connection for transmitting electrical signals.

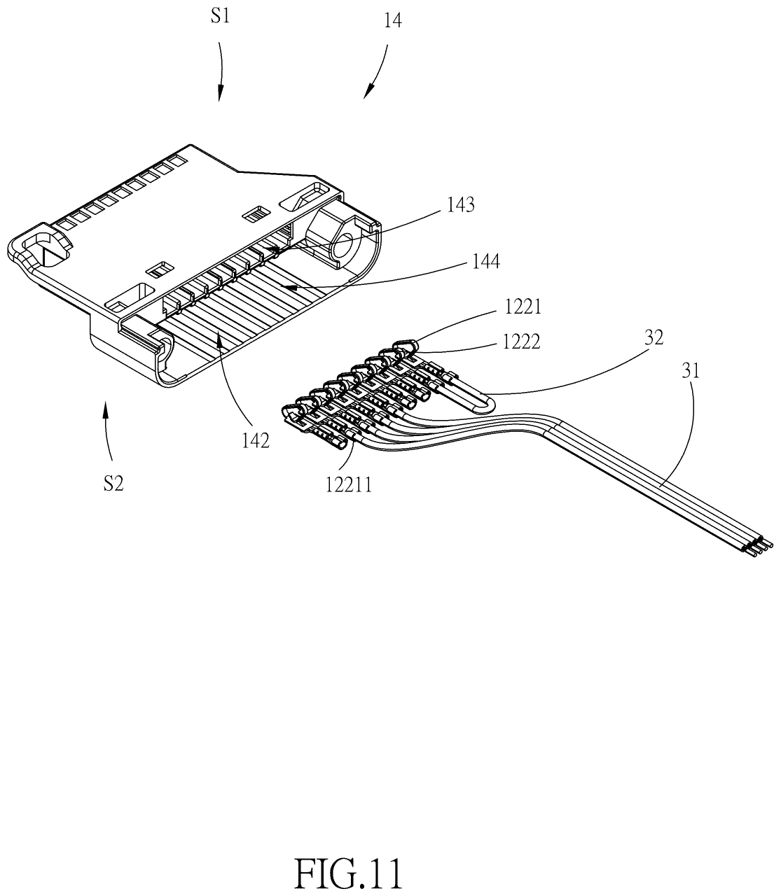

In the embodiments shown in FIGS. 11 to 13, the electrical connector 1 is capable of being equipped with a first minor conductive cable 31 and a second minor conductive cable 32 for transmitting electrical signals. The electrical connector 1 comprises: a major circuit board 11, a conductive terminal assembly 12, a major insulation assembly base 13, an insulation plastic core 14, a major electronic element 15, and a shielding cover 16.

The major circuit board 11 comprises a first major terminal connection circuit 111 and a second major terminal connection circuit 112. The major electronic element 15, for example, is a chip package installed on the major circuit board 11. The major electronic element 15 comprises a first major electronic element pin 151 and a second major electronic element pin 152. The first major electronic element pin 151 is electrically connected to the first major terminal connection circuit 111 through methods such as soldering, welding, or insertion, while the second major electronic element pin 152 is electrically connected to the second major terminal connection circuit 112 through methods such as soldering, welding, or insertion. Thus, the major electronic element 15 can be directly installed within the electrical connector 1 through the major circuit board 11 to perform electrical signal processing, ensuring that the electrical characteristics of the electrical connector 1 meet the requirements of electronic devices.

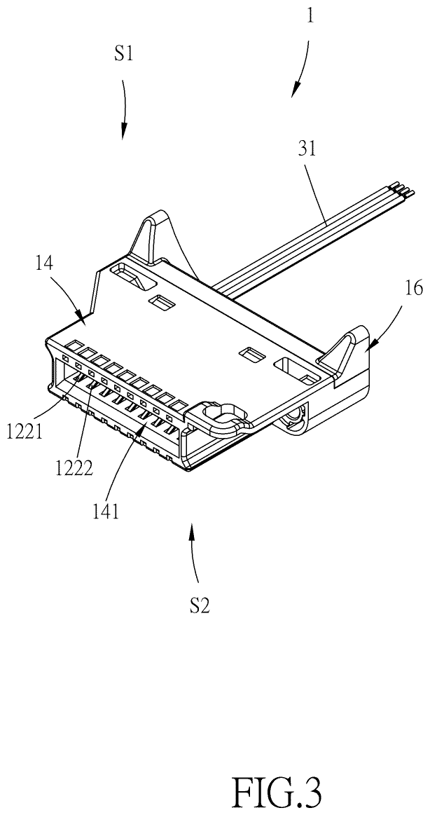

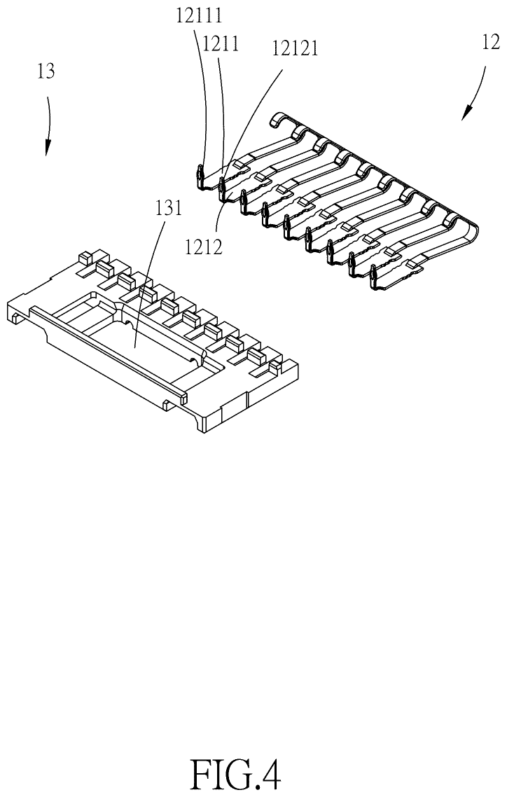

The conductive terminal assembly 12 comprises a first major conductive terminal 1211, a second major conductive terminal 1212, a first minor conductive terminal 1221, and a second minor conductive terminal 1222. In the embodiments shown in FIGS. 4 to 8, the first major conductive terminal 1211 and the second major conductive terminal 1212 have substantially identical forms, allowing for mass production and reducing manufacturing costs of the first major conductive terminal 1211 and the second major conductive terminal 1212. Additionally, in the embodiments shown in FIGS. 3 and 11, the first minor conductive terminal 1221 and the second minor conductive terminal 1222 have substantially identical forms, enabling mass production and reducing manufacturing costs of the first minor conductive terminal 1221 and the second minor conductive terminal 1222.

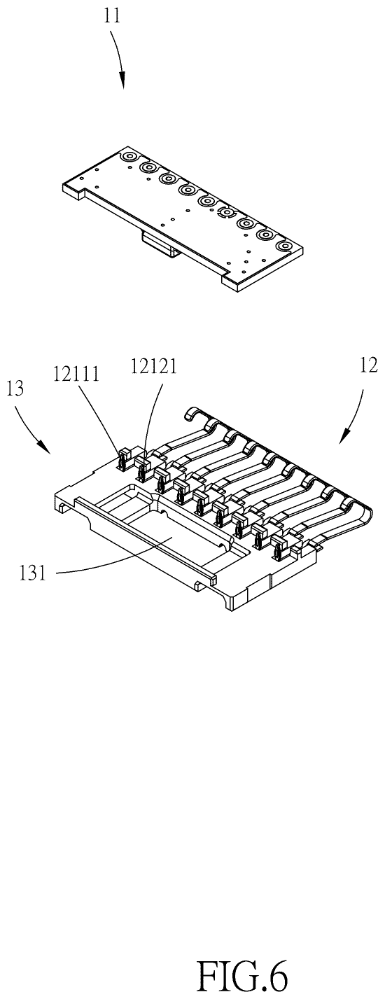

In the embodiments shown in FIGS. 6 to 10 and FIG. 12, the major insulation assembly base 13 is joined with the major circuit board 11, the first major conductive terminal 1211, and the second major conductive terminal 1212, providing support for the major circuit board 11, the first major conductive terminal 1211, and the second major conductive terminal 1212, allowing the first major conductive terminal 1211 to electrically connect to the first major terminal connection circuit 111, and the second major conductive terminal 1212 to electrically connect to the second major terminal connection circuit 112 to provide transmission of electrical signals.

In the embodiments shown in FIGS. 4 to 8, the first major conductive terminal 1211 comprises a first major terminal inserting pin 12111, and the second major conductive terminal 1212 comprises a second major terminal inserting pin 12121. The first major terminal inserting pin 12111 and the second major terminal inserting pin 12121 have insertion structures such as fisheye-shaped structures. The first major terminal inserting pin 12111 inserts into the first major terminal connection circuit 111 of the major circuit board 11, while the second major terminal inserting pin 12121 inserts into the second major terminal connection circuit 112 of the major circuit board 11, thereby electrically connecting the first major conductive terminal 1211 to the first major terminal connection circuit 111, and electrically connecting the second major conductive terminal 1212 to the second major terminal connection circuit 112.

In the embodiments shown in FIGS. 2 to 3 and 11 to 12, the insulation plastic core 14 comprises a major space side S1, a minor space side S2, a plastic core inserting space 141, a plastic core assembly space 142, and a plastic core minor terminal assembly structure 144. The plastic core assembly space 142 is provided for assembling the major insulation assembly base 13, allowing the first major conductive terminal 1211 and the second major conductive terminal 1212 to be located in the major space side S1 and extend into the plastic core inserting space 141, respectively.

Additionally, the plastic core assembly space 142 can also provide the assembly of the first minor conductive terminal 1221 and the second minor conductive terminal 1222, positioning the first minor conductive terminal 1221 and the second minor conductive terminal 1222 in the minor space side S2 and extending into the plastic core inserting space 141. In the embodiments shown in FIGS. 11 to 13, the plastic core minor terminal assembly structure 144 is located within the plastic core assembly space 142, providing the assembly of the first minor conductive terminal 1221 and the second minor conductive terminal 1222, allowing the first minor conductive terminal 1221 to be positioned in the minor space side S2 and extend into the plastic core inserting space 141.

It should be noted that the electrical connector 1 is constructed by assembling the major insulation assembly base 13, the first minor conductive terminal 1221, and the second minor conductive terminal 1222 using the plastic core 14, wherein the major insulation assembly base 13 is joined with the first major conductive terminal 1211 and the second major conductive terminal 1212. Therefore, during the assembly process of the electrical connector, the number of conductive terminals can still be customized to meet the requirements of electronic devices.

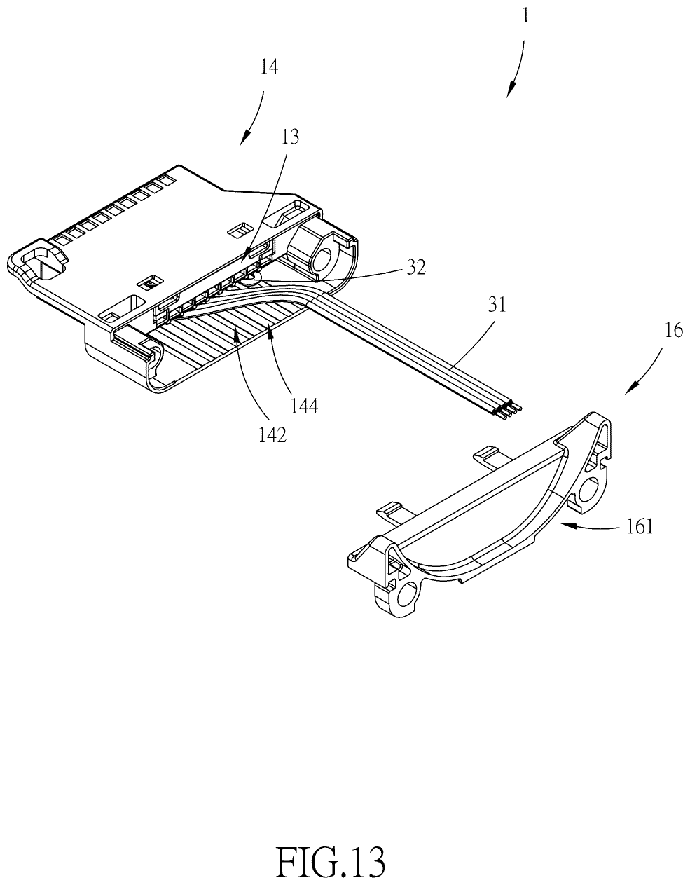

In the embodiment shown in FIG. 13, the shielding cover 16 is capable of joining with the insulation plastic core 14 to provide shielding for the plastic core assembly space 142.

It should be noted that when the inserting component 2 is inserted, the inserting component inserting structure 21 can enter the plastic core inserting space 141, positioning the major inserting component joining part 211 in the major space side S1, and the minor inserting component joining part 212 in the minor space side S2, allowing the major inserting component joining part 211 to respectively join the first major conductive terminal 1211 and the second major conductive terminal 1212 in the major space side S1 to provide electrical signal transmission, similarly, enabling the minor inserting component joining part 212 to respectively join the first minor conductive terminal 1221 and the second minor conductive terminal 1222 in the minor space side S2 to provide electrical signal transmission.

In the embodiments shown in FIGS. 4 to 10 and FIG. 12, the major insulation assembly base 13 is equipped with an assembly base embedding space 131, the assembly base embedding space is provided for embedding the major electronic element 15, thereby preventing interference from the major electronic element 15 with the inserting component inserting structure 21 entering the plastic core inserting space 141, and enabling to reduce the susceptibility of the major electronic element 15 to external forces, thereby extending the lifespan of the major electronic element 15, furthermore, preventing the major electronic element 15 from protruding from the major insulation assembly base 13, enabling effective downsizing of the electrical connector 1, facilitating the continuous development of electronic devices towards being compact and lightweight.

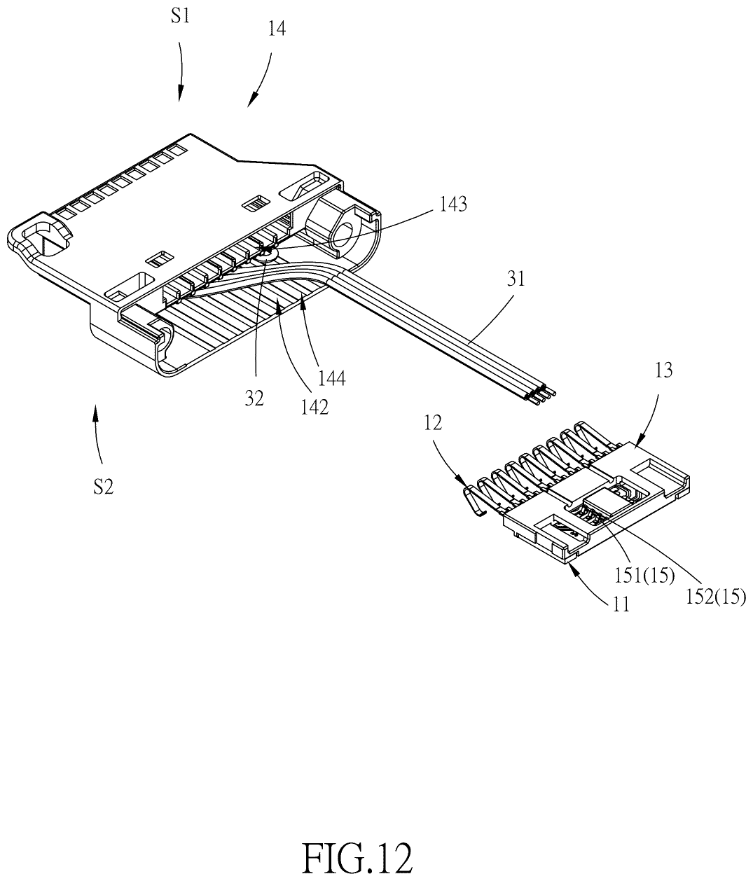

In addition, in the embodiments shown in FIGS. 11 to 12, the insulation plastic core 14 also comprises a plastic core embedding space 143. The plastic core embedding space 143 is provided for embedding the major insulation assembly base 13, thereby preventing the major insulation assembly base 13 from interfering that the inserting component inserting structure 21 enters the plastic core inserting space 141, and preventing the major insulation assembly base 13 from protruding from the insulation plastic core 14, facilitating effective downsizing of the electrical connector 1, further enabling electronic devices equipped with the electrical connector 1 to continue developing towards being compact and lightweight.

In the embodiment shown in FIG. 11, the first minor conductive terminal 1221 comprises a first minor terminal cable clamping structure 12211, and the first minor terminal cable clamping structure 12211 allows to electrically clamp the first minor conductive cable 31 within the plastic core assembly space 142. Furthermore, the insulation plastic core 14 further comprises a plastic core supporting structure 145, and the plastic core supporting structure 145 is positioned beneath the first minor terminal cable clamping structure 12211, providing structural support to the first minor terminal cable clamping structure 12211. Correspondingly, the shielding cover 16 comprises a shielding cover cable passing hole 161, allowing the first minor conductive cable 31 to pass through, enabling the first minor conductive cable 31 to enter the plastic core assembly space 142.

In the embodiments shown in FIGS. 11 to 13, the second minor conductive cable 32 is respectively connected to the first minor conductive terminal 1221 and the second minor conductive terminal 1222, enabling electrical connection between the first minor conductive terminal 1221 and the second minor conductive terminal 1222 to transmit electrical signals, meeting the customized requirements of the electrical connector. Therefore, there is no need to add additional electrical bridging connectors to achieve electrical connection between multiple conductive terminals on the electrical connector, ensuring that the electrical characteristics of the electrical connector in this application meet the requirements of electronic devices.

It should be noted that the foregoing embodiments of the electrical connector in this application can also omit certain components. For example, in the embodiments described herein, the electrical connector may optionally include only: a major circuit board, a conductive terminal assembly, a major insulation assembly base, and an insulation plastic core. The major circuit board comprises a first major terminal connection circuit and a second major terminal connection circuit. The conductive terminal assembly comprises a first major conductive terminal, a second major conductive terminal, and a first minor conductive terminal. The major insulation assembly base is joined with the major circuit board, the first major conductive terminal, and the second major conductive terminal, enabling the first major conductive terminal to be electrically connected to the first major terminal connection circuit, and enabling the second major conductive terminal to be electrically connected to the second major terminal connection circuit. The insulation plastic core comprises a major space side, a minor space side, a plastic core inserting space, and a plastic core assembly space. The plastic core assembly space is provided for assembling the major insulation assembly base and the first minor conductive terminal, positioning the first major conductive terminal and the second major conductive terminal on the major space side, extending into the plastic core inserting space, and positioning the first minor conductive terminal on the minor space side, extending into the plastic core inserting space. During the insertion of the inserting component, the inserting component inserting structure can enter the plastic core inserting space, positioning the major inserting component joining part on the major space side and the minor inserting component joining part on the minor space side, allowing the major inserting component joining part to be respectively joined with the first major conductive terminal and the second major conductive terminal on the major space side, while enabling the minor inserting component joining part to be joined with the first minor conductive terminal on the minor space side.

In summary, this application provides an electrical connector, and the electrical connector is manufactured through an assembly method, enabling the assembly of conductive terminals tailored to the requirements of electronic devices, thereby achieving customized adjustment of the number of conductive terminals in the electrical connector according to the demands. Additionally, the electrical connector comprises a circuit board capable of accommodating electronic elements, ensuring that the electrical characteristics of the electrical connector meet the requirements of electronic devices.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector, capable of providing inserting for an inserting component, wherein the inserting component comprises an inserting component inserting structure, and the inserting component inserting structure comprises a major inserting component joining part and a minor inserting component joining part, and the electrical connector comprises:
a major circuit board, comprising a first major terminal connection circuit and a second major terminal connection circuit;
a conductive terminal assembly, comprising a first major conductive terminal, a second major conductive terminal, and a first minor conductive terminal;
a major insulation assembly base, joining the major circuit board, the first major conductive terminal, and the second major conductive terminal, enabling the first major conductive terminal to be electrically connected to the first major terminal connection circuit and the second major conductive terminal to be electrically connected to the second major terminal connection circuit; and
an insulation plastic core, comprising a major space side, a minor space side, a plastic core inserting space, and a plastic core assembly space, and the plastic core assembly space provides the assembly of the major insulation assembly base and the first minor conductive terminal, positioning the first major conductive terminal and the second major conductive terminal on the major space side and extending into the plastic core inserting space respectively, and positioning the first minor conductive terminal on the minor space side and extending into the plastic core inserting space;
wherein, during insertion of the inserting component, the inserting component inserting structure can enter the plastic core inserting space, positioning the major inserting component joining part within the major space, and positioning the minor inserting component joining part on the minor space side, enabling the major inserting component joining part to join with the first major conductive terminal and the second major conductive terminal on the major space side, and enabling the minor inserting component joining part to join with the first minor conductive terminal on the minor space side.

2. The electrical connector of claim 1, further comprising a major electronic element, wherein the major electronic element is positioned on the major circuit board, and the major electronic element comprises a first major electronic element pin and a second major electronic element pin, wherein the first major electronic element pin is electrically connected to the first major terminal connection circuit, and the second major electronic element pin is electrically connected to the second major terminal connection circuit.

3. The electrical connector of claim 2, wherein the major insulation assembly base comprises an assembly base embedding space, and the assembly base embedding space provides space for embedding the major electronic element, thereby avoiding the major electronic element interfering that the inserting component inserting structure enters the plastic core inserting space.

4. The electrical connector of claim 1, wherein the first major conductive terminal comprises a first major terminal inserting pin, and the first major terminal inserting pin is inserted into the first major terminal connection circuit, enabling the first major conductive terminal to be electrically connected to the first major terminal connection circuit, similarly, the second major conductive terminal comprises a second major terminal inserting pin, and the second major terminal inserting is inserted into the second major terminal connection circuit, enabling the second major conductive terminal to be electrically connected to the second major terminal connection circuit.

5. The electrical connector of claim 1, wherein the first major conductive terminal and the second major conductive terminal are substantially identical in form.

6. The electrical connector of claim 1, wherein the insulation plastic core also comprises a plastic core embedding space, and the plastic core embedding space provides embedding of the major insulation assembly base, thereby avoiding the major insulation assembly base interfering that the inserting component inserting structure enters the plastic core inserting space.

7. The electrical connector of claim 1, further comprising a shielding cover, and the shielding cover can be joined with the insulation plastic core to provide shielding for the plastic core assembly space.

8. The electrical connector of claim 7, wherein the electrical connector is capable of being equipped with a first minor conductive cable, wherein the first minor conductive terminal comprises a first minor terminal cable clamping structure, and the first minor terminal cable clamping structure can electrically clamp the first minor conductive cable within the plastic core assembly space, additionally, the insulation plastic core further comprises a plastic core supporting structure positioned beneath the first minor terminal cable clamping structure to provide structural support for the first minor terminal cable clamping structure.

9. The electrical connector of claim 8, wherein the shielding cover comprises a shielding cover cable passing hole, and the shielding cover cable passing hole provides the first minor conductive cable to pass through, enabling the first minor conductive cable to enter the plastic core assembly space.

10. The electrical connector of claim 1, wherein the electrical connector is capable of being equipped with a second minor conductive cable, wherein the conductive terminal assembly further comprises a second minor conductive terminal, and the second minor conductive cable is respectively connected to the first minor conductive terminal and the second minor conductive terminal, thereby enabling the first minor conductive terminal to be electrically connected with the second minor conductive terminal.

11. The electrical connector of claim 10, wherein the first minor conductive terminal and the second minor conductive terminal are substantially identical in form.

12. The electrical connector of claim 10, wherein the insulation plastic core further comprises a plastic core minor terminal assembly structure, and the plastic core minor terminal assembly structure is located within the plastic core assembly space, providing the assembly of the first minor conductive terminal and the second minor conductive terminal.
